(19) United States
(12) Patent Application Publication
(10) Pub. No.: US 2022/0132823 A1
(43) Pub. Date: May 5, 2022

(54) Combined Personal Comfort Device and Pest Control Device for Flying Insects

(71) Applicant: Dennis Brown, Arkadelphia, AR (US)

(72) Inventor: Dennis Brown, Arkadelphia, AR (US)

(21) Appl. No.: 17/085,470

(22) Filed: Oct. 30, 2020

(51) Int. Cl. A01M 1/06; A01M 1/22; F04D 25/08

(52) U.S. Cl. CPC A01M 1/06; F04D 25/08; A01M 1/223

(57) ABSTRACT

A device that provides personal comfort to the user while simultaneously providing insect control, both functionalities facilitated by a fan component that creates airflow through the device, such airflow drawing insects into the inlet end of the device for insect control and blowing air out of the outlet end of the device for personal comfort of the user, while a trapping component inside the device prevents the insects from exiting with the outlet air and a killing component inside the device kills the insects for insect control purposes.

### CROSS REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

Pests can be a big nuisance for people who like to enjoy outdoor activities like reading a book on a back porch on a warm summer evening. And in some areas, there is one pest that is the worst perpetrator: the mosquito. Although most types of mosquitoes are just nuisance mosquitoes, some types of mosquitoes can actually spread viruses that cause disease. In fact, the CDC warns that disease epidemics from viruses spread by mosquitoes are happening more often and urges everyone to take common-sense actions to help protect from these annoying insects. It's no shock, then, that there are a number of different products available on the market that help reduce human exposure to mosquito bites. These products include topical sprays that repel the pests and even UV light zappers that attract the insects for killing. Unfortunately, often times repellant sprays themselves can be somewhat harmful to humans, pets, or more beneficial insects. Likewise, currently available electrical zappers use lights to attract the mosquitoes, and unfortunately, these zappers attract and kill more beneficial insects and are wildly ineffective at attracting and killing mosquitoes. What is needed is a safe device that can help reduce exposure to mosquitoes while reducing or eliminating the risk to more beneficial insects.

### BRIEF SUMMARY OF THE INVENTION

The present invention is directed to an insect control device. More particularly, the present invention is directed to a device for trapping and killing mosquitoes while reducing or eliminating the likelihood of trapping and killing other (more beneficial) insects, all while serving as a means of personal comfort to the user. In this regard, the device is both a personal comfort device and an insect control device. The device includes a fan component that is both capable of providing airflow and comfort while simultaneously acting as means for drawing mosquitoes into the device. Once the mosquitoes are drawn inside, an electrified dual-mesh assembly traps and kills the mosquitoes. These and other objects, features, and advantages of the present invention will become better understood from a consideration of the following detailed description of the preferred embodiments and appended claims in conjunction with the drawings as described following:

### BRIEF DESCRIPTION OF THE DRAWINGS

FIG. 1 is a perspective view of one embodiment of the present invention.

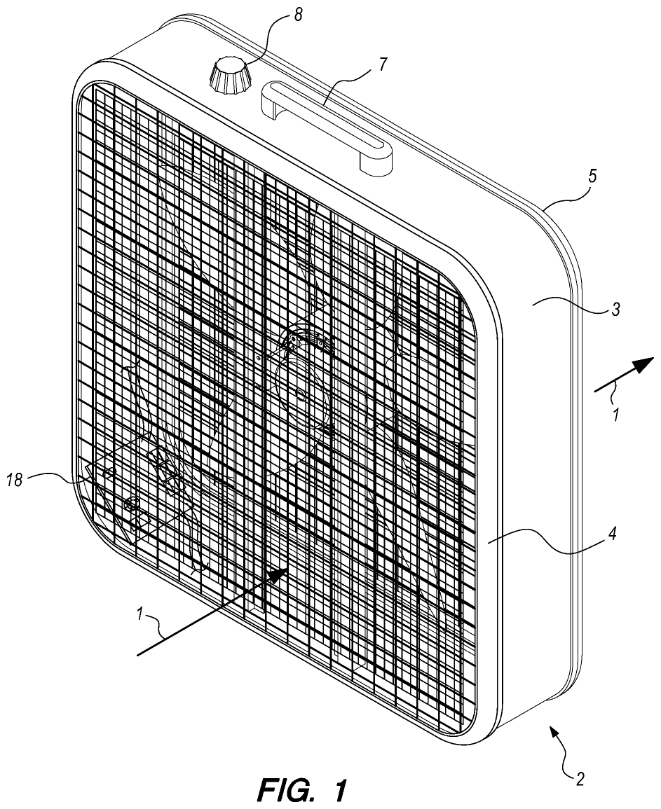

FIG. 2 is an exploded perspective view of one embodiment of the present invention.

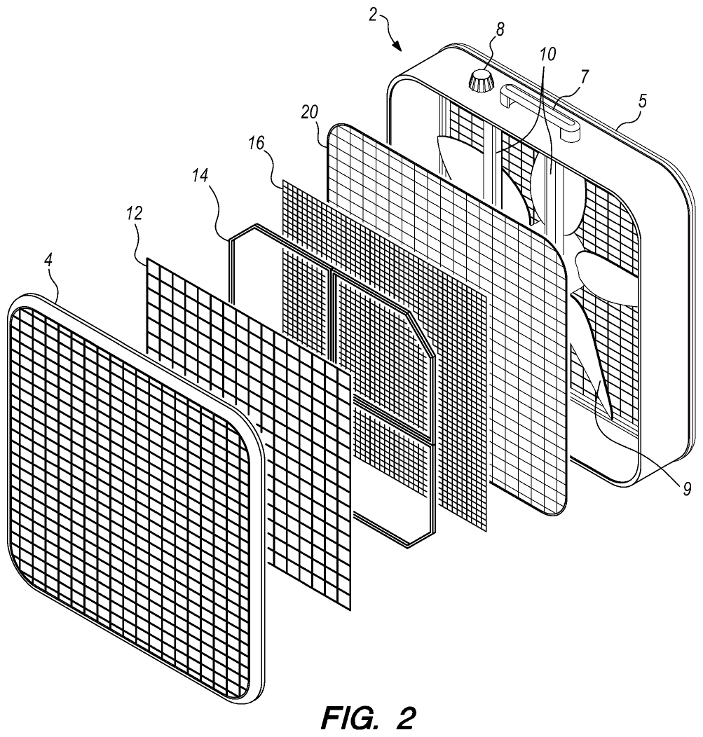

FIG. 3 is schematic of a side view of one embodiment of the various layers of the present invention.

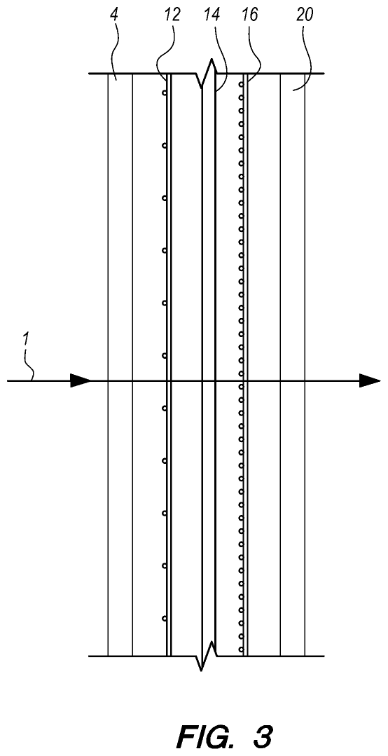

FIG. 4 is a front view showing one embodiment of the present invention, with cutaways to show the various layers of the present invention.

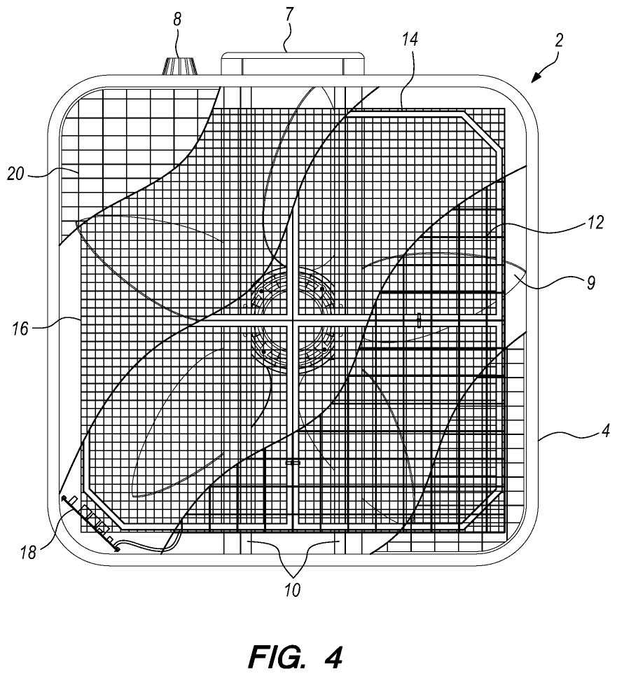

### DETAILED DESCRIPTION OF THE INVENTION

Generally speaking, the present invention is directed to an insect control device, and more particularly, the present invention is directed to a flying insect control device, and even more particularly, the present invention is directed to a mosquito control device. It is a feature of the present invention that the device not only trap and kill mosquitoes but also provide airflow as a means of personal comfort to users in the vicinity of the device (who also act as a natural mosquito lure to the device vicinity). In this regard, the device acts as both a personal comfort device and an insect control device. Generally speaking, the device includes a number of components that form a housing defining an outer periphery such that there is said to be positions inside the device (those within the outer periphery) and positions outside the device (those outside the outer periphery of the device). Many device components, including the operable fan components and the operable bug-zapping components are positioned inside the device. The device functions such that mosquitoes that are flying outside of the device are pulled into the device and killed inside the device, as described more below.

As noted above, and as shown in the figures, the device of the present invention includes a housing 2 that defines the outer periphery of the device. While it is understood that multiple housing designs may be utilized, it is important that the housing 2 be configured in a way to allow for both airflow into the device (to pull mosquitoes into the device) and adequate airflow out of the device (to provide personal comfort to the user). In the preferred embodiment, the housing 2 generally includes one or more side walls 3 positioned between a front plate 4 and a back plate 5 to form an internal compartment having a depth equal to the width of the sidewalls 3. The front plate 4 and back plate 5 are each in the form of a grill or grate with openings 6 to provide air passages through both ends of the device. The openings 6 are generally large enough that the user can see through the openings 6 but are generally small enough to prevent human appendages to enter the device as to avoid injury that would occur by coming into contact with the components internal to the device, which are described more below. This preferred embodiment of the housing 2 of the device may be considered to be generally “box” shaped, as is a term frequently used to describe square shaped fans (e.g. “box fans”) or may take one of many other shapes or designs so long as the device includes a housing 2 that defines an outer periphery and provides an internal space to hold the internal components of the device and in which the mosquitoes are lured and killed. For example, generally cylindrical shaped housing 2 or other configurations may be utilized so long as airflow into and out of the device is achieved.

In one embodiment, the housing 2 may further include one or more handles 7, thereby allowing the device to be easily transported between different positions. In addition, the housing 2 may include feet or legs (not shown) to allow the device to be easily placed on a surface and remain upright and steady on the surface while in use. Finally, in one embodiment, the device housing 2 may include a button, knob 8, or other control feature allowing the user to power the device and/or control and modify the functionality of the device when in use. The device may be operated by battery or may be operated by plugging the device into an electrical outlet. In addition to these various features, it may also be seen that the device is made of generally lightweight (perhaps plastic) components as to allow the device to be more easily transported. This allows the device to be used in a variety of scenarios where personal comfort and pest control may be desired.

As noted above, the housing 2 of the device forms an outer periphery that in turn creates an internal space inside the device. This internal space is where many of the functional components of the device are positioned. One such functional component is the fan component of the device. The fan component both acts as the mechanism for providing airflow for personal comfort to the user and also as the mechanism for drawing the mosquitoes into the device for trapping and killing. The fan component includes a rotating arrangement of blades 9, which are configured to rotate around a hub or shaft 10 to provide airflow through the device of the present invention in the operable direction parallel to the shaft 10 about which the blades 9 rotate. A motor component, which is run by electric current when the device is powered, is attached to the fan blades 9 via the shaft 10. The motor is operable to rotate the shaft 10 (and therefore the blades 9), thereby causing the airflow through the device.

Because mosquitoes are weak flyers, as air is drawn into the device from one direction by the rotation of the blades 9, mosquitoes flying within that airflow are pulled into the device. It should be noted, of course, that the strength of the airflow generated by the fan is preferably insufficient to pull in other more beneficial insects that are not as weak at flying as mosquitoes, thereby preventing the trapping and killing of these more beneficial insects. In this regard, the present invention is an improvement over existing insect control devices, which tend to trap and kill even the more beneficial insects in much higher quantities than mosquitoes. Furthermore, it should be noted that in the preferred embodiment, the axis on which the fan blades 9 rotate in a direction extending between the front plate 4 and back plate 5 of the device; thus, the airflow created by the fan component is in that direction. And even more particularly, the airflow is such that air is drawn into the device through the front plate 4 and flows through the device until it exits from the openings 6 in the back plate 5. Thus, the front plate 4 is positioned on the air inlet end and the back plate 5 serves as the air outlet end. This movement of air out of the back plate 5 provides personal comfort to the user of the device (as the user is positioned adjacent to the back plate 5), while the air flow into the front plate 4 draws the mosquitoes into the device for trapping and killing. Of course, it should be noted that without a trapping component positioned inside the device, the mosquitoes would be drawn into the device through the front plate 4 and then pushed out of the device through the back plate 5 with the airflow. This is not desirable (because as noted, the user is positioned adjacent the back plate 5) and therefore is avoided utilizing the trapping and killing components described below.

Once the mosquitoes are drawn into the device, they are trapped and killed. In order for the mosquitoes to effectively be drawn into the device, the openings 6 in the grate of the front plate 4 of the device housing 2 (as discussed above) must be of sufficient size to allow mosquitoes to pass into the device. However, as noted above, without an internal trapping component, the mosquitoes would simply pass through the device with the air and the desired pest control would not be achieved. Instead, in order to keep the mosquitoes from passing through the device, an internal trapping component is utilized. In the preferred embodiment, the internal trapping component includes a dual-layer mesh assembly. An outer, larger mesh layer 12 (i.e. the layer closer to the front plate 4 of the device) has larger openings to allow the mosquitoes to pass through the large mesh layer 12, while an inner, smaller mesh layer 16 (i.e. the layer closer to the back plate 5 of the device) is smaller in order to trap the mosquitoes and prevent the mosquitoes from exiting the device through the back plate 5 openings 6. In the preferred embodiment, the larger mesh layer 12 has half inch openings while the smaller mesh layer 16 has eighth inch openings. In one embodiment, a support layer 20, which may be a plastic grate or thicker mesh layer, may be utilized to support the smaller mesh layer 16. In any event, the trapping component allows the device to be used as a personal comfort device (i.e. allows for airflow out of the device) while reducing or entirely eliminating the safe exiting of mosquitoes from the device. It is contemplated that in one embodiment the device could be modified such that the back plate 5 of the device includes such small openings that no mosquito could escape the device; however, this modification would severely limit or entirely eliminate the device's ability to provide personal comfort via airflow out of the device. This, of course, is not desirable, and therefore, appropriately sized openings in the back plate 5 of the device are preferred.

Once the mosquitoes have been drawn into the device by the airflow caused by fan component and trapped inside the device by the trapping component, the mosquitoes are preferably killed by a killing component. In the preferred embodiment, the killing component is an electrical zapping component, which is operable to electrocute the mosquitoes once trapped. The electrical zapping component is configured such that each of the mesh layers 12, 16 of the trapping component are wired to an electrical component 18. A spacer 14 separates the mesh layers 12, 16, providing a short distance between the layers 12, 16. As the mosquitoes are drawn into the device and through the larger outer mesh layer 12, the mosquitoes become positioned in the small space between the mesh layers 12, 16 that is created by the spacer 14. The built-up voltage potential in the mesh layers 12, 16 is discharged when the mosquito touches both layers 12, 16 simultaneously, thereby electrocuting and killing the mosquito. In the preferred embodiment, a plastic eighth inch spacer 14 is used to separate the mesh layers 12, 16 and provide the space for mosquito positioning for electrocution.

It may be seen that because the device of the present invention relies on the force of the airflow created by the fan component to draw insects into the device for trapping and killing (and not on some other lure like a UV light), larger insects that are strong enough to avoid being pulled into the device by the airflow are trapped and killed at much lower rates than with traditional insect control devices or are avoided entirely. Furthermore, it has been determined that mosquitoes are not attracted to traditional UV bug zappers at the same high rates as other more beneficial insects; instead, mosquitoes appear to be more drawn to skin odors and carbon dioxide, which is exhaled by humans. Thus, the device of the present invention not only provides comfort to the user, but also acts as an insect control device as the mosquitoes become attracted to the carbon dioxide exhaled by the user. In this regard, the device preferably does not rely on any artificial lures and instead provides mosquito protection to users as they enjoy the comfort created by the airflow of the device. This allows the user to reduce or eliminate the need for chemical bug sprays.

In one embodiment, the device may be configured to include a fan-reversing mechanism such that the fan's rotation can be reversed such that the airflow is directed opposite the normal flow of air such that the air is directed out of the device through the original air inlet. This particular mechanism may be useful after normal use to expel the killed insects (which are trapped inside the device by the trapping component) back out through their original inlet. This allows the user to clean the dead insects from the device easily after use. Alternatively, the user may place the device in off-mode (for example by unplugging the device) and use some other air source (such as another fan) to blow the dead insects from the trapping component of the device.

Unless otherwise stated, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein. It will be apparent to those skilled in the art that many more modifications are possible without departing from the inventive concepts herein.

All terms used herein should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. When a Markush group or other grouping is used herein, all individual members of the group and all combinations and subcombinations possible of the group are intended to be individually included. All references cited herein are hereby incorporated by reference to the extent that there is no inconsistency with the disclosure of this specification. When a range is stated herein, the range is intended to include all sub-ranges within the range, as well as all individual points within the range. When “about,” “approximately,” or like terms are used herein, they are intended to include amounts, measurements, or the like that do not depart significantly from the expressly stated amount, measurement, or the like, such that the stated purpose of the apparatus or process is not lost.

The present invention has been described with reference to certain preferred and alternative embodiments that are intended to be exemplary only and not limiting to the full scope of the present invention, as set forth in the appended claims.

1. A personal comfort and insect control device comprising:
a. an air inlet end;
b. an air outlet end;
c. a fan component configured to create airflow into the device through the air inlet end and provide airflow out of the device through the air outlet end, further wherein the airflow into the device is operable to draw one or more insects into the device, and further wherein the airflow out of the device is operable to provide personal comfort to the user;
d. an insect trapping component, wherein upon the drawing of one or more insects into the device by the fan component, the insect trapping component is configured to prevent the one or more insects from exiting the device through the air outlet end; and
e. an insect killing component, wherein upon the drawing of one or more insects into the device by the fan component, the killing component is configured to kill the one or more insects.

2. The device of claim 1, wherein the fan component comprises a shaft and a number of blades configured to rotate about the shaft, thereby providing the airflow through the device.

3. The device of claim 1, wherein the insect trapping component comprises a first mesh layer positioned inside the device, wherein the first mesh layer comprises a number of openings of a size operable to prevent movement of the one or more insects through the first mesh layer.

4. The device of claim 3, wherein the insect killing component comprises a second mesh layer positioned adjacent the first mesh layer between the first mesh layer and the air outlet end, wherein the second mesh layer comprises a number of openings of a size operable to allow movement of the one or more insects into a space between the first mesh layer and the second mesh layer, whereby upon a simultaneous touching of the first mesh layer and the second mesh layer by the one or more insects, an electrical charge is triggered thereby killing the one or more insects.

5. The device of claim 3, wherein the first mesh layer comprises one-eighth inch openings.

6. The device of claim 4, wherein the second mesh layer comprises half inch openings.

7. The device of claim 1, wherein the insect killing component comprises an electrical component configured to electrocute the one or more insects.

8. A device useful for both providing personal comfort and providing insect control, the device comprising:
a. a fan component;
b. a trapping component; and
c. a killing component
wherein the fan component is configured to provide airflow through the device, thereby operable to draw one or more insects into device, and wherein the trapping component is configured to prohibit the movement of the one or more insects through the device, and wherein the killing component is configured to kill the one or more insects drawn into the device.

9. The device of claim 8, wherein the fan component comprises a shaft and a number of blades configured to rotate about the shaft, thereby providing the airflow through the device.

10. The device of claim 8, wherein the insect trapping component comprises a first mesh layer positioned inside the device, wherein the first mesh layer comprises a number of openings of a size operable to prevent movement of the one or more insects through the first mesh layer.

11. The device of claim 10, wherein the insect killing component comprises a second mesh layer positioned adjacent the first mesh layer between the first mesh layer and the air outlet end, wherein the second mesh layer comprises a number of openings of a size operable to allow movement of the one or more insects into a space between the first mesh layer and the second mesh layer, whereby upon a simultaneous touching of the first mesh layer and the second mesh layer by the one or more insects, an electrical charge is triggered thereby killing the one or more insects.

12. The device of claim 10, wherein the first mesh layer comprises one-eighth inch openings.

13. The device of claim 11, wherein the second mesh layer comprises half inch openings.

14. The device of claim 8, wherein the insect killing component comprises an electrical component configured to electrocute the one or more insects.

15. A device useful for killing only weak-flying insects, the device comprising:
a. a fan component;
b. a trapping component; and
c. a killing component
wherein the fan component is configured to provide airflow through the device, whereby the airflow is operable to draw only weak-flying insects into device, and wherein the trapping component is configured to prohibit the movement of the weak-flying insects through the device, and wherein the killing component is configured to kill the weak-flying insects drawn into the device.

16. The device of claim 15, wherein the fan component comprises a shaft and a number of blades configured to rotate about the shaft, thereby providing the airflow through the device.

17. The device of claim 15, wherein the insect trapping component comprises a first mesh layer positioned inside the device, wherein the first mesh layer comprises a number of openings of a size operable to prevent movement of the weak-flying insects through the first mesh layer.

18. The device of claim 17, wherein the insect killing component comprises a second mesh layer positioned adjacent the first mesh layer between the first mesh layer and the air outlet end, wherein the second mesh layer comprises a number of openings of a size operable to allow movement of the weak-flying insects into a space between the first mesh layer and the second mesh layer, whereby upon a simultaneous touching of the first mesh layer and the second mesh layer by the weak-flying insects, an electrical charge is triggered thereby killing the weak-flying insects.

19. The device of claim 18, wherein the first mesh layer comprises one-eighth inch openings and wherein the second mesh layer comprises half inch openings.

20. The device of claim 15, wherein the insect killing component comprises an electrical component configured to electrocute the weak-flying insects.
